(19) United States
(12) Patent Application Publication
(10) Pub. No.: US 2015/0361689 A1
(43) Pub. Date: Dec. 17, 2015

(54) KEYS AND CORRESPONDING KEY ASSEMBLIES

(71) Applicants: Massimo VALENTE, Anet (FR); Marco MIGLIASSO, Torino (IT)

(72) Inventors: Massimo VALENTE, Anet (FR); Marco MIGLIASSO, Torino (IT)

(21) Appl. No.: 14/307,083

(22) Filed: Jun. 17, 2014

(51) Int. Cl. E05B 19/00

(52) U.S. Cl. CPC E05B 19/00

(57) ABSTRACT

A key whose blade is made of interchangeable elements with different bitting, which are mounted by inserting them one into the other along a central shaft which is common to all the elements and is fixed inside the bow or handle of the key. At the free end of the key opposite the bow, the shaft is solid with an end element that bears a locksmith's key code that is specific to a particular production series of keys and corresponding cylinders. Between the bow and the blade, there is a blade base which is integral with the bow and does not have a bitting. In flat keys, particularly those said to be symmetrical, guide ribs will be provided advantageously on the blade base, on the different interchangeable elements and on the end elements of the shaft, to guide the blade into the keyway of the corresponding lock cylinder.

This invention concerns the field of locksmithing. It is aimed to improve the conditions under which keys can be manufactured and duplicated while respecting a pre-determined signature pattern that corresponds to the code combination required for the keys to open or close the corresponding lock. In doing so, the invention is aimed to ensure the exact duplication of the code combination, the mechanical solidity of the key itself, its resistance to repeated use over the course of time, the quality of the profile and reliable protection against breaking and entering.

Although the invention is not limited to a particular type of key, its main interest lies in its reduction to practice in the case of so-called high security systems where the duplication of keys can pose problems. These include so-called multi-bit keys and cylinders, particularly so-called “flat keys” named after the shape of the rectangular cross-section of their tip.

From this viewpoint, the invention mainly consists of a key whose functional blade part is modular, that is, it can consist of various shapes based on individual interchangeable elements.

In this respect, the invention is similar to that of the prior art described in particular in the text of patent AU 6779 163 B3 (JPH PING KUO, concerning a key with a bow and blade, projecting from a shoulder formed at the base of a neck at the junction of the bow and the blade, said blade having a characteristic signature pattern achieved by the combination of different bittings, in which said bittings are at least partly supported separately by individual interchangeable elements.

Thus, according to the invention, the signature blade comprises interchangeable elements each with its own bitting that are inserted one into the other along a common shaft in a series of successive elements slotted together and said shaft, which is fixed into the bow of the key, is integral at its opposite end with an end element that has a locksmith's key code that is specific to a particular production series of keys and their corresponding cylinders. According to the other characteristics specific to the invention, the shaft and one of the blade elements, that is, the distal blade element placed opposite the bow, is integral with the corresponding end of the shaft while the other blade elements in the series are slotted together along the shaft. The shaft is inserted into a blind hole drilled through said blade base by a fixation system which is secured transversally in the neck, so that the blade elements are inserted between the distal blade element integral with the shaft and the blade base integral with the bow. Furthermore, the blade base has the same external cross-section as that of the blade elements, but without bittings while the blade elements each have a specific bitting, in the form of impressions in one of their faces, such that the type of blade element and the order in which the elements are placed results in a signature pattern that is specific to the key.

According to a particular characteristic of the invention which is specific to the case of its application to keys with symmetrical bits, the blade base, the blade elements, the interchangeable movable elements and the fixed element at the end of the central shaft all have an external cross-section that is identical to the ribbed profile surface-mounted on each side of the blade. Once the key has been mounted, said ribs are aligned along the entire length of the blade. The blade part thus has a ribbed profile that reinforces the rigidity of the key and helps to guide it into the corresponding keyway of the cylinder, which has complementary broaching on each side whose dimensions are complementary to those of the rib.

Based on sets of interchangeable elements available in several models that each have different bittings, a key cutting machine will not be needed to duplicate the keys with their various signature patterns. In a typical case, it is possible to have as many sets of elements of the same model as there are elements in each assembled key.

The key in the invention has several advantages, including a high degree of modularity and durability when inserted into the corresponding lock, which is not affected by said modularity.

Modularity of the key is due to the interchangeability of the blade modules comprising the key, ensuring mounting diversity that increases the security of the key assembly. The number of signature patterns that can be produced from the different interchangeable elements according to the invention obviously depends on the number of elements comprising each key. It also depends on the variety of element models available, with each model being characterised by its own bitting or combination of bittings. The bittings are generally in the form of impressions designed to take spring-loaded pins located in the rotating part of a corresponding lock cylinder, not shown in the figures. In the case of bit keys in particular, it will not be unusual, for each interchangeable blade element, to have several impressions of different depths on each of the four sides of the rectangular section of a flat key.

In this context, the combined presence of a blade base integral with the regular neck of the key and an end blade element on the distal end of the shaft which is fixed to the bow of the key will increase the sturdiness of the key assembly by tightly pressing together the different blade elements slotted into each other along the shaft. The blade base, advantageously devoid of bittings, is configured so that it will engage with the blade part inside the cylinder rotor. It is located at the front part of the associated rotor which is naturally also devoid of pins. This arrangement has the advantage of separating the key and cylinder drive functions from the lock and unlock functions of the lock.

This results in greater overall solidity of the key and greater operating security. The drive forces in the cylinder rotor are exerted on the part of the neck that forms a single piece with the bow, once the correspondence has been obtained between the impressions and the bitting pins. This takes pressure off the blade which comprises several assembled parts. Since the blade elements are reserved for reading the bitting combination, the connections between the elements and the central shaft are less exposed to damage during use.

Furthermore, said distal element solid with the shaft has the advantage of also forming the first signature element. The bittings provided on the element for this purpose can advantageously include the characteristic mark of a particular lock manufacturer.

The longitudinal position of the key is determined according to the way in which the blade is fixed to the bow. A rivet can advantageously be inserted into the bow at the point where a groove is cut around the circumference of the shaft to let it pass through. However, it must be clearly understood that this type of fixation in a given longitudinal position does not limit the invention in any way. In the variant mentioned here by way of example, the shaft could be clipped into the receiving bore to obtain an equivalent fixation method.

In conjunction with said key design, the invention shall provide key duplicating shops with kits containing interchangeable sets of elements, with identical blade base and bitting elements in each set, arranged and indexed according to their bittings. The same kit can advantageously contain a large number of mounting shafts which support and are integral with a distal blade element and are designed to take a pre-determined number of blade elements pressed tightly against the integral distal element, as well as the same number of bows each designed to take a shaft with a series of blade elements mounted thereon.

The way in which the successive elements in the series are each slotted together is preferably the same for all the elements, so that they are strictly interchangeable. In this case, the different elements, each with its own bitting(s), all have the same basic external shape, characterised by a rectangular or oblong cross-section in the case of flat keys. It will be noted that the fact that the removable shaft elements are fitted together by slotting the previous one into the next one along the length of the shaft actively contributes to the solidity of the mechanical mounting. However, the presence of a specific bitting on the non-removable end element considerably improves the safety of the lock by preventing the removable elements being replaced by anyone who does not have the corresponding mounting shafts. Since said shafts equipped with their end elements will be supplied exclusively to authorised locksmiths, only the latter will be able to duplicate the keys according to the invention for their customers.

A longitudinal hole is drilled through the blade elements, the cross-section of which is complementary to that of the shaft, whether it is simply smooth and circular or whether it is grooved, fluted or of otherwise non-circular cross-section, which may be useful for ensuring failsafe mounting so that the elements cannot be slotted into each other in the wrong direction.

Furthermore, their opposite sides in the longitudinal direction have complementary shapes so that they can be slotted together, that is, if the two opposite sides are designated as the front and back respectively, the front and the back have complementary shapes, one a projection and the other a depression and vice versa. Where applicable, it could be useful for said complementary shapes to have a sufficiently different relief between the projections and the depressions to be visible to the naked eye, such that the person carrying out the mounting will immediately know, without requiring any further reference being required, the direction in which the element is to be inserted onto the receiving shaft. Preferably also, said complementary shapes will help to distinguish the direction in which the elements are placed on the shaft with respect to the other, which illustrates a construction variant of the failsafe effect mentioned above.

By way of example, we will take the case of flat keys once again. It would appear particularly advantageous to give the insertion shapes a continuous profile across the width of the blade flat and a distinctive profile across its thickness, which is achieved in particular by cooperating tenon and mortise profiles. Thus, an element whose front has a projecting tenon profile will be slotted one-to-one into a previous element whose back has a corresponding mortise profile.

Furthermore, and particularly in the case that has just been mentioned, it is generally preferable that on the front surface into which the element mounting shaft is inserted, the bow has the same profile as the back surface of the different interchangeable elements, which means that the bow and the last element inserted onto the shaft slot together.

To make it easier to understand the particular characteristics and usefulness of the reduction to practice of the invention and the advantages afforded, we will now describe an example of a particular reduction to practice, referring to the figures in the drawings below. In doing so, we will take the case of application of the invention to the construction of high-security, difficult-to-duplicate keys for bit lock systems, called bit keys by analogy, and more particularly bit keys with flat blades and multiple bitting impressions on the different blade faces.

The composition of the key in its different construction variants will be described as well as the process to be implemented for construction of the keys corresponding to a particular signature pattern (as defined on a key order card) and its application based on a lock set especially designed for this purpose.

On the drawings accompanying the descriptive text:

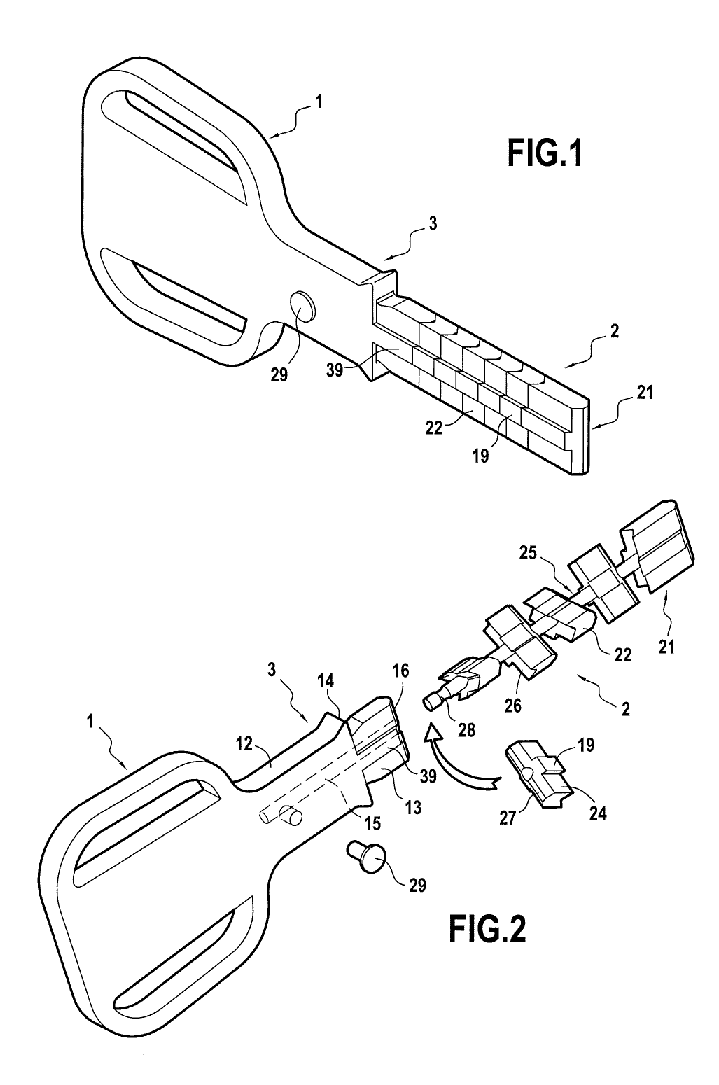

FIG. 1 is a schematic bird's eye view of a modular key according to the invention in its finished state;

FIG. 2 is an exploded view of the key according to FIG. 1 showing the interchangeable elements during mounting on a central shaft not yet inserted into the bow;

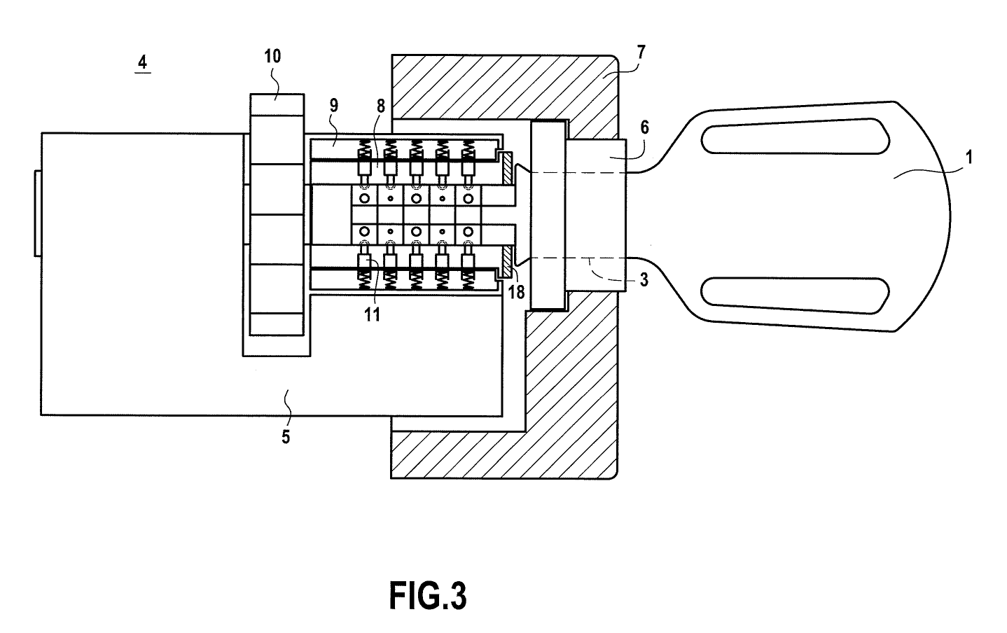

FIG. 3 is a diagram of a key according to the invention inserted into a corresponding lock cylinder;

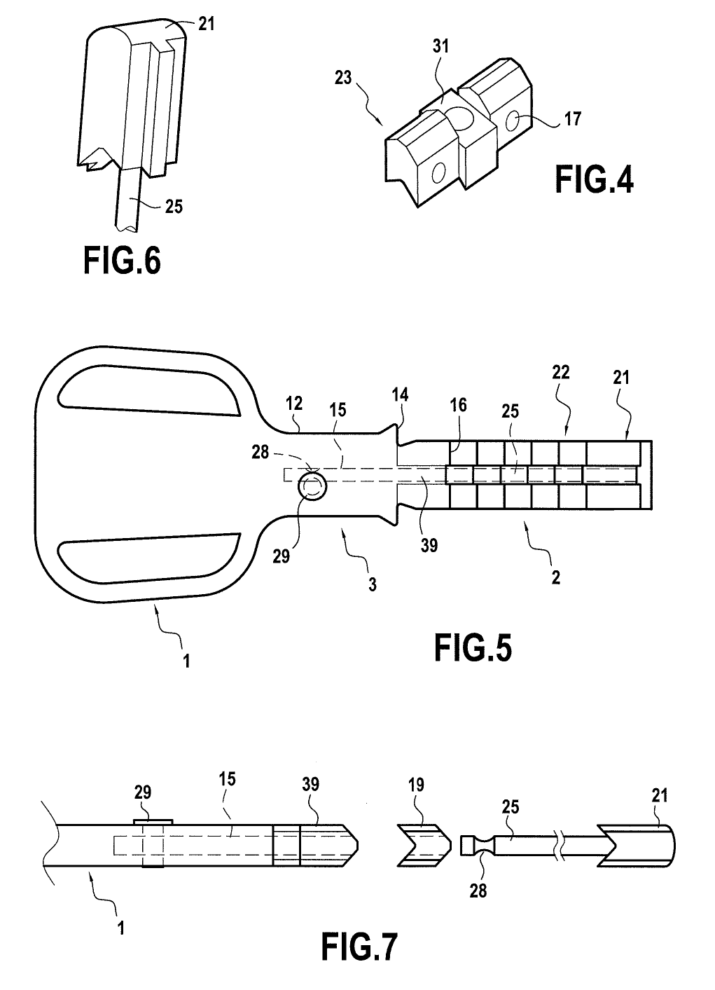

FIG. 4 is a close-up of a particular model of blade element among the various interchangeable elements illustrated in FIG. 2;

FIG. 5 is a front view of the key illustrated in FIG. 1;

FIG. 6 is a close-up of an element mounting shaft and a distal blade element integral with the shaft; and

FIG. 7 is a diagram of a key during construction seen from the edge of its rectangular cross-section.

The same reference numbers are used on all the figures to represent the same component parts of a complete key when the parts are not noticeably different from one model to another among the different variants that will be mentioned. However, it should be understood that the models chosen to illustrate the reduction to practice are not limited in any way and it must also be understood that the different variants which have been described since the beginning of the text or which will be described subsequently can be combined with each other to produce further variants that will remain within the framework and scope of the invention.

Each illustration of the key shows a bow 1 and a blade 2 which is a longitudinal extension of said bow, projecting beyond a shoulder 14 formed by the neck 3 of the junction between the bow and blade part.

The bow 1 is a handle used to hold the key and turn it in the lock. It always remains outside the lock set, as illustrated by the reference 4 on FIG. 3. Normally, the neck 3 remains outside cylinder 5 of the lock and inside a rotating ring 6, which can rotate freely in a cylinder cover 7 which covers the cylinder on the outside of the lock and has an appropriately-shaped keyway so that the key can be inserted until it reaches the functional position required to operate the lock.

FIG. 3 also shows the rotor 8 and stator 9 of the cylinder 5 and the cog wheel 10 which serves as a movement transmission unit to throw the lock bolt by rotation of the key once it is correctly inserted in the cylinder.

Since the invention is illustrated by the example of a flat key, the blade 2 is flat, in a single plane, along its entire functional length receiving the signature pattern which establishes the one-to-one correspondence with the cylinder of the lock that the key is designed to open and close. Here it has a rectangular cross-section. However, on each of its larger sides, the blade has a ribbed profile (longitudinal rib 19) that helps to guide the key when it is being inserted into the keyway of the cylinder which has to corresponding broaching on each side. The ribs complete the failsafe effect already provided by the cooperating slotting profiles.

The blade bits correspond to blind holes in the blade forming depressions of varying depths with respect to the plane of the reference surface of the blade. Their diameter can also vary, and sometimes their shape, both with regard to their cross-section and the curved surface at the bottom of the hole. Some are machined on the larger sides of the blade, others on the edges. It will be considered here that they are always characteristic impressions of different bittings, with the overall combination of the bittings comprising the signature pattern specific to the key and its corresponding cylinder.

Details will be given below of the key feature relating to the position of the bits on the blade.

In accordance with said signature pattern, the functional part of the cylinder cooperating with the key blade is perfectly normal. It can thus be seen in FIG. 3 that the rotor 8 of the cylinder has various pins 11 which can move upwards or downwards in the rotor, while in the stator 9 of the cylinder, counter-pins are mounted which are individually spring-loaded to push against the pins so that they will be placed opposite. When a key with the correct signature pattern is inserted into the cylinder, the different pins, pushed by the corresponding counter-pins towards the centre of the rotor, tend to take up position at the bottom of the impressions. The key is thus coupled with the cylinder rotor 8, which enables the user to open or close the lock.

Flat keys are generally reversible, that is, unlike paracentric keys, their shape and the arrangement of their impressions are symmetrically opposite. The advantage is that they can thus be inserted indifferently in either direction into the keyway of the corresponding lock cylinder. As a result, the invention is particularly useful in its application to both bit keys and flat keys, regardless of whether the configuration of the bit keys is reversible or not and regardless of whether the flat keys have a rectangular or oblong cross-section.

The key according to the invention will now be described with its modular functional blade part.

The blade 2 has a blade base 13 and an added part which are made integral with each other.

The blade base is integral with neck 3 and extends along the axis of the key, whose cross-section is smaller than that of the neck. At the end opposite the neck, the blade base has an edge 16 facing the added part with a blind hole 15 through its center extending axially inside the bow of the key (FIG. 2).

The added part has a shaft 25 and blade elements 22, which include elements that can be mounted interchangeably along the axis of the bow of the key, and a distal element 21 or fixed end element which is integral with the shaft. The different elements are pressed up against each other and have complementary profiles so that they will slot together, one in front and the other behind each of the elements taken in the direction in which they are inserted one after the other onto the shaft 25. It is understood that the front of the integral distal element can have a different profile since it is fixed into position and can only be used to slot into another blade element. On the other hand, the back profile of the integral distal element 21 is the same as that of the interchangeable blade elements.

The end elements are interchangeable in that a particular shaft, with its distal element 21, can be made integral with the standard bow. Said distal element is rendered specific to a manufacturer or production series by the configuration of its signature pattern, and/or specific to a particular mechanical configuration by the fact that it is integral with said configuration. For this purpose, as can be seen in the figures, the distal element 21 has an axial dimension, that is, a longitudinal dimension taken in the direction of the shaft, which is greater than the axial dimension of the blade elements 22 inserted onto the shaft. Advantageously, the distal element 21 is twice as large as each of the blade elements, which increases the number of possible combinations to form a complete key signature pattern specific to a production series of keys and key assemblies.

The external shape of the cross-section of the blade base 13 is identical to that of the blade elements, such that the entire blade is the same shape.

As illustrated in the figures, the blade part advantageously has a ribbed profile along its entire length. The interchangeable elements 22 and the integral distal element 21 have a ribbed profile along the key: a raised rib 19 is formed in the middle of each of the larger sides of the blade part. Once the key has been mounted, the ribs are aligned with each other. This makes the key easier to use by guiding its insertion into the receiving cylinder of a lock due to the fact that the lock has special broaching which is complementary to two symmetrical grooves on either side of the keyway. To ensure its correct insertion, the straight cross section of the blade base 13 has the same profile as that of the blade of the key, that is, that of the different elements comprising it. It can thus be seen in the figures that there is a rib 39 in the center of each side that is an extension of blade rib 19, and extends from the front edge 16 to shoulder 14 of the bow.

The various elements are designed to slot tightly into each other when mounted one after the other on the central shaft so that the resulting connection does not interfere in any way with the operation of the blade as such.

In the case of the flat key considered in the particular construction method described and illustrated in the figures, the connection between two adjacent elements requires corresponding tenon and mortaise to profiles formed in the plane of the flat key in the thickness between its two larger sides. The profile in question has a V-shaped cross-section with a blunted point, which is approximately rectilinear in the middle of the thickness of the key and extends over its entire width, from one side of the element to the other.

It can also be observed in the figures that in each element, the hollow profile section 26 is on the bow side of the key, at the back of the element while the projecting profile 27 is on the opposite side, at the front of the element, on the side of the tip of the key. This construction method has been preferred in the particular case described for reasons of commodity when constructing the key.

During construction of the key, the successive blade elements are inserted onto the central mounting blade starting with the distal end of the shaft, that is, at the tip of the key, and going towards its proximal part where it is inserted in blind hole 15.

The last element mounted has a rear slotting profile on the proximal side which is complementary to that of the edge 16 which is at the end of the bow in front of the neck 3. In a variant of reduction to practice which will be mentioned here, the profile could be different and require a last blade element with a specific slotting profile. It must be ensured that this does not interefere with the solidity of the mounted assembly. In the case described in relation to the figures, the profiles are easy to identify.

Means must be therefore be provided to stop the shaft rotating and moving in translation with respect to the key. The shapes that enable the elements to slot together help to prevent rotation and, inside the bow of the key, shaft 25 is secured by a rivet 29 which is inserted into a groove 28 provided for this purpose around the shaft near its proximal end. A bolt or cone-point set screw could also be envisaged. In the case considered, the use of a rivet has the advantage of preventing the key from being dismounted. When the central shaft 25 is thus immobilised in its position in the longitudinal direction of the key, it ensures the solidity of mounting of the elements by forcing them to remain slotted together, held tightly between the integral distal element 21 and the blade base 13.

According to another series of particular features of the key described in reference to the specific features of the invention, the blade base 13 does not have any bittings while the interchangeable blade elements and the end element of the tip do have bittings.

Each of these elements can be characteristic of a bitting which is specific to the element concerned and is combined with the different bittings of the other elements to form the overall signature pattern of the key. On each element, the bitting will depend on the structure of its different blade bits defined by the impressions machined on its surface and corresponding to the pins and counter-pins of a cooperating cylinder (such as impression 17 on FIG. 4) and the way in which they are arranged in relation to each other. Thus, it is considered here that the bitting specific to each element is itself a combination of individual bittings.

As described previously, a shoulder 14 is formed between the neck 3 and the blade base 13, which is of a smaller width than neck 3 with which it is integral. When the key is inserted in the lock cylinder, shoulder 14 comes up against cylinder 5 (FIG. 3), or, more exactly onto a ring 18 at the end of rotor 8. The blade base 13 penetrates the keyway in the rotor along a length that is devoid of any signature elements. It is thus ensured that it is at this level that the rotational drive forces of the rotor are exerted by rotation of the key with respect to the stator, once a correspondence has been established between the respective signature elements of the key and the cylinder. As a result, the complementary profiles designed so that the blade elements will slot together no longer have to support the rotational forces, which contributes to the solidity of the key.

To conclude, we will now consider the key construction process to according to the invention.

It can already be understood from the description above that construction of the key according to the invention, usually known as duplicating, is no longer a question of reproducing the shape. The shop duplicating the keys no longer needs a key cutting machine. The key assembly provided comprises what will be designated here as sets of elements to be assembled on-site according to the signature pattern indicated on the key order card that corresponds to the lock for which the keys are to be duplicated. If the owner has lost all the keys, the shop can provide a new key based on the codes indicated on the key order card.

In each set, all elements of the same model are identical and characterised by an overall bitting, which corresponds to one or several impressions on each element. The elements are presented in a kit with the various elements arranged and indexed according to the different models, in addition to a series of mounting shafts, one end of which has an integral distal blade element, an equivalent number of bows and a sufficient number of rivets to immobilise the resulting assemblies. Where necessary, tweezers will be added to pick up the blade elements to be assembled and, more particularly, to position and buck the rivet into the key.

When a customer asks for a key to be duplicated from the manufacturer's kit, the blade elements to be used are selected according to the signature pattern to be respected (indicated on the key order card, for example) and said elements are inserted successively onto the mounting shaft taken from the same kit, together with the corresponding bow. The shaft with the elements slotted together along its length is then inserted into the receiving bore in the bow. It is then fixed into a longitudinal position in which it tends to slot the elements tightly together.

As an example, a key with five blade elements having a key code designating a lock manufacturer on the end element 21, will produce 81 sets in the same kit. A simple calculation shows the feasibility of 163 billion different signature patterns in the same kit. It should be noted that the end element of the blade part is not included in the calculation because it is not considered to be really interchangeable with the others. It is deemed to be specific to a manufacturer or production series by the configuration of its signature pattern, and/or specific to a particular mechanical configuration by the fact that it is integral with said configuration.

1. Key comprising a bow and a blade to take the signature pattern which is a longitudinal extension of said bow, projecting beyond a shoulder formed by a neck between the bow and the blade, said blade having a signature pattern specific to the key resulting from a combination of different bittings,
in which the blade designed to take the signature pattern comprises at least two interchangeable blade elements each of which has its own particular bitting and are mounted by inserting them one into the other along a central shaft which is common to all of them and is fixed inside the bow or handle of the key,
said blade also comprising a fixed distal element which is integral with said shaft at its free end opposite said bow and has a locksmith's key code that is specific to a particular set of keys to be produced with signature patterns all comprising the same locksmith's key code but being differentiated by the bittings on the interchangeable blade elements to be mounted on the shaft.

2. Key according to claim 1 in which the blade to take the signature pattern comprises a blade base integral with the bow which lies in the extension of said neck so that it will engage with the cylinder having a complementary signature pattern (that of the blade).

3. Key according to claim 1 in which said shaft on which are mounted interchangeable elements together with its end element is chosen from a series of interchangeable shafts.

4. Key according to claim 2, in which said shaft is inserted into the bow through a blind hole extending from said blade base to said neck, its fixation being provided by a fixation system secured transversely in the neck.

5. Key according to claim 2 in which the blade base has the same external cross-section as that of the blade elements, but without bittings, while the blade elements each have a specific bitting, in the form of impressions in one of their faces, such that the type of blade element and the order in which the elements are placed results in a signature pattern that is specific to the key in conjunction with the locksmith key code formed by the bittings of said end element.

6. Key according to claim 2 in which the interchangeable blade elements, the end element of the central shaft and said blade base have ribs mounted on each side of the blade which, once the blade is mounted in the bow, are aligned with each other.

7. Key according to claim 1, in which the bow and the end element of the shaft have the same profiles for successive insertion along the shaft as those of the interchangeable blade elements, with complementary projection and depression shapes for the reduction to practice of the insertion function and a sufficiently different relief between the projections and depressions to be visible to the naked eye.

8. Key according to claim 1, in which the signature elements among said interchangeable elements have angular bittings for cooperation with pins in a cylinder rotor with a complementary signature pattern.

9. Key assembly for the construction of keys according to claim 1, in the form of a kit containing sets of interchangeable blade elements, each identical to each other in each set, arranged and indexed according to their bittings, in addition to a large number of mounting shafts designed to take a pre-determined number of said elements with an integral blade element on one end, and bows designed to each take a shaft on which a series of blade elements has been mounted.

10. Key construction process according to claim 1, using a key assembly, that consists of taking a bow and a mounting shaft comprising an integral distal blade element from the kit, inserting interchangeable blade elements successively selected according to the signature pattern to be respected by the finished key onto the shaft, inserting the shaft supporting the elements slotted together as above into a receiving bore drilled in the bow and fixing it in the longitudinal position in which it tends to press the different elements tightly together.
